(19) United States
(12) Patent Application Publication
(10) Pub. No.: US 2013/0049680 A1
(43) Pub. Date: Feb. 28, 2013

(54) ELECTRONIC DEVICE

(71) Applicant: Tomoki Katsumata, Kanagawa (JP)

(72) Inventor: Tomoki Katsumata, Kanagawa (JP)

(73) Assignee: PANASONIC CORPORATION, Osaka (JP)

(21) Appl. No.: 13/643,461

(22) PCT Filed: Oct. 20, 2011
(86) PCT No.: PCT/JP2011/005897

§ 371 Date: Oct. 25, 2012

(30) Foreign Application Priority Data
Dec. 7, 2010 (JP) 2010-272194

(51) Int. Cl. H02J 7/00

(52) U.S. Cl. 320/107

(57) ABSTRACT

An electronic device includes an electronic device main body, a USB connection unit, a VBUS detecting unit, a USB control unit, a battery contained in the electronic device main body, a battery monitoring unit, a charging control unit, a switch, and, a system control unit that controls the switch and the charging control unit. The VBUS detecting unit detects connection of the USB device. If the USB control unit determines that D+ and D− terminals of the USB connection unit are not short-circuited, when a battery voltage obtained from the battery monitoring unit is a preset threshold value or less, the system control unit starts charging of the battery.

### TECHNICAL FIELD

The present invention relates to an electronic device having a battery-deterioration preventing function of avoiding unintentional charging, by a user by providing a determining whether to start a charging when starting the charging through USB, as a technology related to control on USB charging.

### BACKGROUND ART

Users who charge electronic devices, each of which has a USB communication function and using a battery as a main power supply, from a DC power supply of 5V supplied from a VBUS terminal which is a USB interface of a PC or the like, by use of a dedicated device for USB charging or a general-purpose USB communication cable, other than dedicated chargers, as a charging type, have been increasing. The USB (Universal Serial Bus) is a standard for a serial interface that is set by a plurality of companies, and is used for published computer systems and the like.

A USB cable according to the USB standard has a power supply line of +5V, a ground line, and two D+ and D− signal lines. The USB cable according to the USB standard can supply 500 mA at +5V while transmitting signals. A type of performing charging using this power supply is called USB charging. In the USB charging, it also is possible to detect a short-circuited state of the two D+ and D− signal lines on the basis of the USB standard, so as to determine that a connected device is a dedicated device for USB charging.

Further, Micro-USB connectors were standardized and thus it has been possible to reduce USB connectors in size and thickness and to mount the USB connectors in portable devices. Therefore, it is fully predicted that the USB charging will be a standard charging specification for the future.

A technology of Patent Document 1 is one of those examples. The technology of Patent Document 1 is a technology of simply connecting an output voltage of a VBUS to a power supply line of a portable phone. However, actually, a method of performing communication and charging using a general-purpose communication cable available at relatively low cost in consideration of convenience is general. In this general method, even in a case where USB connection is performed only for the purpose of communication, the VBUS is supplied to a charging circuit. Therefore, charging unintended by a user starts such that the number of times of unnecessary charging increases, and cycle deterioration is facilitated.

In contrast, a technology disclosed in Patent Document 2 is an example of control on charging according power supply from a USB interface using a general-purpose USB communication cable. An electronic device disclosed in Patent Document 2 includes a data communication unit that transmits and receives signals through a USB interface, a battery-charging control circuit that charges a battery, a distributor circuit that distributes power of the VBUS for data communication and charging, a micro computer that concentratedly controls those circuits, and the like.

When the data communication unit operates, the distributor circuit supplies the VBUS power supply to the data communication unit, and when the data communication unit does not operate, the distributor circuit supplies the VBUS power supply to the battery-charging control unit, whereby the electronic device disclosed in Patent Document 2 performs switching between communication and charging. However, the electronic device disclosed in Patent Document 2 controls supply of the power supply to the charging control circuit only on the basis of existence or non-existence of communication. Therefore, distribution of the distributor circuit is frequently controlled, that is, start and stop of charging are frequently repeated. For this reason, in the electronic device disclosed in Patent Document 2, it is impossible to stop facilitating deterioration of a charging cycle.

Patent Document 3 discloses a charging-start control technology that reduces the number of times of charging, thereby extending the lift of a secondary battery. The technology disclosed in Patent Document 3 is implemented by providing a voltage detecting unit that detects the voltage of the secondary battery, and a switch unit that performs control such that, when the voltage of the secondary battery detected by the voltage detecting unit is a predetermined charging start voltage or less, a voltage is supplied from a charging device to the secondary battery, and when the voltage of the secondary battery is larger than the predetermined charging start voltage, the voltage is not supplied from the charging device to the secondary battery.

However, in the technology disclosed in Patent Document 3, since the charging start threshold value is uniformly fixed, in a situation in which it is predicted that a time interval to the next charging will lengthen, or the like, at least charging is performed for a long time. Therefore, even in a case where it is desired to lengthen an available time, if the voltage of the battery is the threshold value or larger, a phenomenon in which charging does not start occurs, and thus, convenience is very bad. In other words, if the threshold value is set to be high, the number of times of charging increases, and if the threshold value is set to be low, the convenience becomes bad. Therefore, there is a problem in which it is impossible to determine a unique threshold value.

### CITATION LIST

### Patent Document

[Patent Document 1] JP-A-2000-201204

[Patent Document 2] JP-A-2001-202163

[Patent Document 3] JP-A-2002-075463

### DISCLOSURE OF THE INVENTION

### Problems to be Solved by the Invention

An object of the present invention is to provide an electronic device capable of solving the above-mentioned problems, preventing a cycle deterioration of a battery, and highly-convenient charging control.

### Means for Solving the Problems

In order to solve the above-mentioned problems according to the related art, as an aspect of the present invention, it is provided an electronic device which includes a main body, a USB connection unit provided to the main body, a VBUS detecting unit that determines that a USB device has been connected to the USB connection unit, a USB control unit that detects whether D+ and D− terminals of the USB connection unit are short-circuited, thereby determining whether the connected USB device is a dedicated device for USB charging, a battery contained in the main body, a battery monitoring unit that monitors the state of the battery, a charging control unit that charges the battery, a system control unit that controls supply of power from the USB device connected to the USB connection unit to the charging control unit.

According to the above-mentioned configuration, the electronic device is characterized in that the electronic device includes a determining unit that determines whether a connected USB device is a dedicated device for charging, on the basis of the states of the D+ and D− terminals of the USB connection unit, when it has been detected that the USB device has been connected.

Further, as the aspect of the present invention, the above-mentioned electronic device is characterized in that, in a case where it is determined, as a result of the determination on the USB connection unit that a dedicated charger for USB has been connected, determination on start of charging based on a charging start threshold voltage is performed, and in a case where it is determined that a device other than the dedicated charger for USB has been connected, determination on start of charging according to the charging start threshold voltage is not performed.

As the aspect of the invention, there is provided an electronic device including: an electronic device main body, a USB connection unit provided to the electronic device main body, a VBUS detecting unit that determines that a USB device has been connected to the USB connection unit, a USB control unit that detects whether D+ and D− terminals of the USB connection unit are short-circuited, a battery contained in the electronic device main body, a battery monitoring unit that monitors the state of the battery, a charging control unit that charges the battery, a switch that controls supply of power from the USB device connected to the USB connection unit to the charging control unit, and a system control unit that controls the switch and the charging control unit, and the VBUS detecting unit detects connection of the USB device, and if the USB control unit determines that the D+ and D− terminals of the USB connection unit are not short-circuited, when a battery voltage obtained from the battery monitoring unit is a preset threshold value or less, the system control unit starts charging of the battery.

Also, as the aspect of the invention, the VBUS detecting unit detects the connection of the USB device, and if the USB control unit determines that the D+ and D− terminals of the USB connection unit are short-circuited, charging of the battery is started.

Also, as the aspect of the invention, the VBUS detecting unit detects the connection of the USB device, and if the USB control unit determines that the D+ and D− terminals of the USB connection unit are not short-circuited, when the battery voltage obtained from the battery monitoring unit is a preset threshold value or larger, supply of power to the charging control unit is not performed.

### Effects of the Invention

As described above, according to the present invention, it is possible to suppress facilitation of the cycle deterioration of the battery, thereby extending the life of the battery, while securing convenience.

### BRIEF DESCRIPTION OF THE DRAWINGS

FIG. 1 is a block diagram illustrating a configuration of an electronic device 1 according to a first embodiment of the present invention.

FIG. 2 is a flow chart illustrating an operation of the electronic device 1 according to the first embodiment of the present invention.

FIG. 3 is a block diagram illustrating a configuration of an electronic device 2 according to a second embodiment of the present invention.

FIG. 4 is a flow chart illustrating an operation of the electronic device 2 according to the second embodiment of the present invention.

### MODE FOR CARRYING OUT THE INVENTION

Embodiments of the present invention will be described below with reference to the drawings.

### First Embodiment

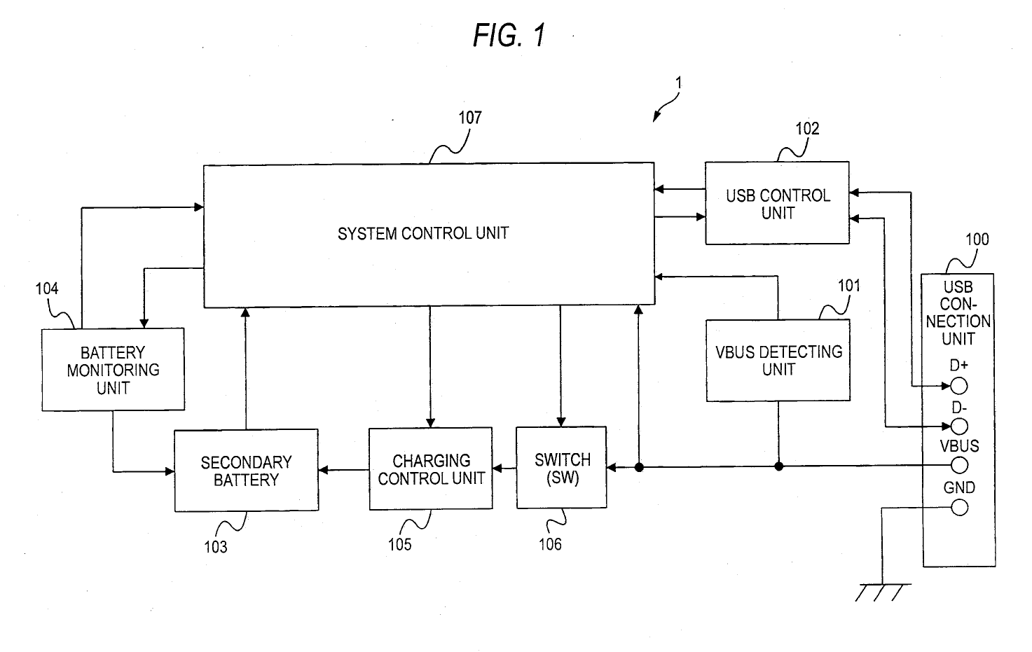

FIG. 1 is a block diagram illustrating a configuration of an electronic device 1 according to a first embodiment of the present invention. Referring to FIG. 1, the electronic device 1 according to the first embodiment of the present invention includes a USB connection unit 100 provided to a main body of the electronic device, a VBUS detecting unit 101 that determines that a USB device has been connected to the USB connection unit 100, a USB control unit 102 that observes the states of D+ and D− terminals of the USB connection unit 100 and determines whether the connected USB device is a dedicated device for charging, a secondary battery 103 contained in the main body of the electronic device, a battery monitoring unit 104 that monitors the state of the secondary battery 103, a charging control unit 105 that charges the secondary battery 103, a switch (SW) 106 that is a switch unit that switches whether to supply power from the USB device connected to the USB connection unit 100 to the charging control unit 105, and a system control unit 107 that controls the switch (SW) 106 and the charging control unit 105 on the basis of outputs from the USB control unit 102 and the battery monitoring unit 104.

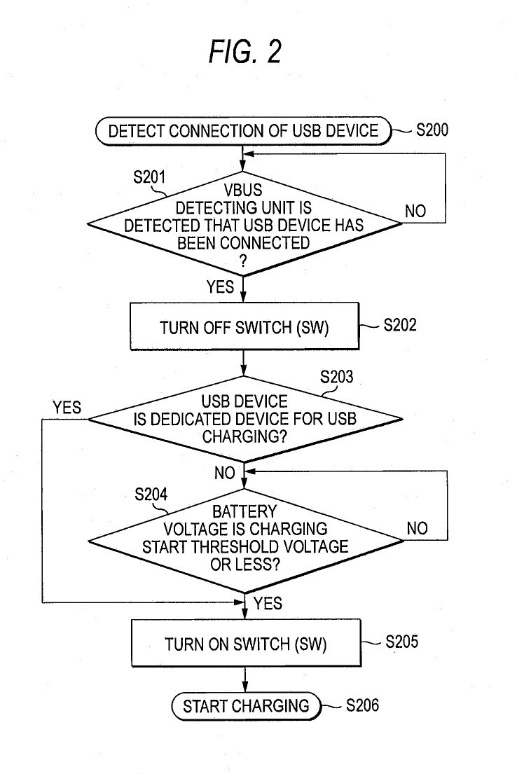

Next, an operation of the first embodiment of the present invention will be described in detail with reference to FIG. 2. FIG. 2 is a flow chart illustrating an operation of the electronic device 1 according to the first embodiment of the present invention. First, if a user connects a USB device to the USB connection unit 100 of the electronic device 1, the VBUS detecting unit 101 of the electronic device 1 detects that the USB device has been connected, in STEP S200, and notifies the system control unit 107 that the USB device has been connected, in STEP S201.

Next, if it is notified by the VBUS detecting unit 101 that the USB device has been connected, the system control unit 107 turns off the switch (SW) 106 in STEP S202.

Also, in STEP S201, it is determined whether a VBUS has detected that the USB device has been connected to the electronic device 1.

Next, in STEP S203, the system control unit 107 requests the USB control unit 102 to perform observation on the states of the D+ and D− terminals, and the USB control unit 102 notifies the system control unit 107 of the result of the observation on the states of the D+ and D− terminals. In a case where it is determined as the result of the observation of the USB control unit 102 on the D+ and D− terminals that the D+ and D− terminals have been short-circuited, the system control unit 107 determines that the connected USB device is a dedicated device for USB charging (‘Yes’ in STEP S203).

Then, the system control unit 107 turns on the switch (SW) 106 in STEP S205, and supplies power to the charging control unit 105, thereby immediately starting charging the secondary battery 103 in STEP S206.

Next, in a case where it is determined as the result of the observation of the USB control unit 102 on the states of the D+ and D− terminals that the D+ and D− terminals have not been short-circuited, the system control unit 107 determines that a device other than a dedicated device for USB charging has been connected using a general-purpose communication cable or the like (‘No’ in STEP S203).

Next, in STEP S204, the system control unit 107 obtains battery voltage information from the battery monitoring unit 104, and compares a battery voltage with a preset charging start threshold voltage. In a case where the battery voltage is the charging start threshold voltage or less (‘Yes’ in STEP S204), the system control unit 107 turns on the switch (SW) 106 in STEP S205, and supplies power to the charging control unit 105, thereby starting charging in STEP S206.

In a case where the battery voltage is the charging start threshold voltage or larger (‘No’ in STEP S204), the system control unit 107 turns off the switch (SW) 106 such that charging does not start, until the battery voltage becomes the charging start threshold voltage or less.

As described above, in the present embodiment, only in a case where a device other than a dedicated device for USB charging is connected, determination on whether to start charging is performed on the basis of the charging start threshold voltage, whereby it is possible to suppress facilitation of the cycle deterioration of the battery, thereby extending the life of the battery, while securing convenience.

Further, although it has been described in the present embodiment that the determination is performed on the basis of the result of a single threshold value determination in consideration of processing time, the present invention is not limited thereto, but the determination may be performed on the basis of the results of multiple threshold value determinations.

Here, in the electronic device 1 according to the first embodiment, the system control unit 107 compares the battery voltage included in the battery voltage information obtained from the battery monitoring unit 104, with the preset charging start threshold voltage for the battery voltage. However, the value of the battery voltage obtained from the battery monitoring unit 104 is an example of the battery voltage information. In an electronic device 2 according to a second embodiment, another example of the battery voltage information will be described.

### Second Embodiment

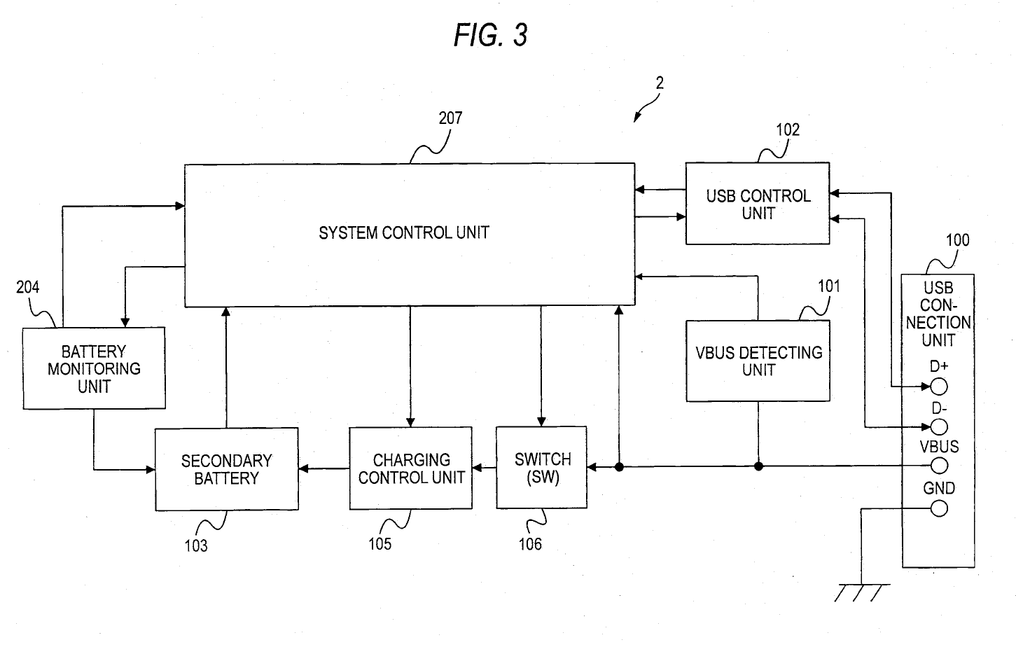

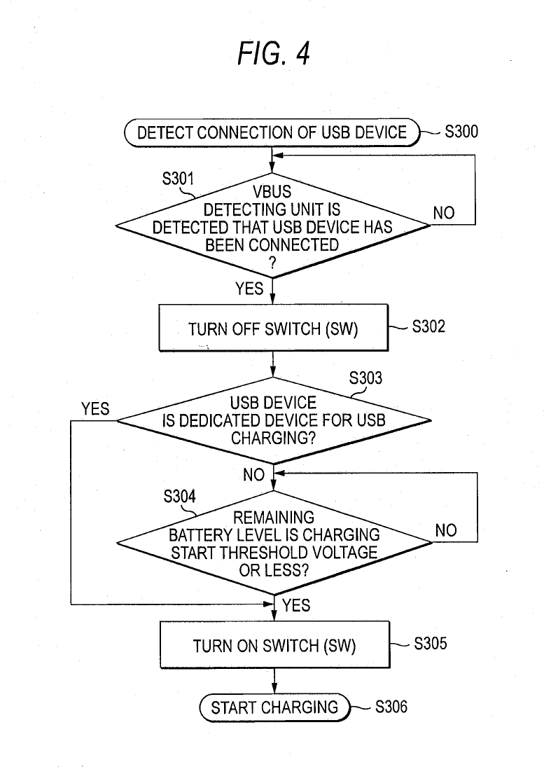

Next, an operation of the second embodiment of the present invention will be described in detail with reference to FIGS. 3 and 4. FIG. 3 is a block diagram illustrating a configuration of an electronic device 2 according to a second embodiment of the present invention. In a configuration of the electronic device 2 according to the second embodiment of the present invention, identical components to those of the first embodiment are denoted by the same numerals.

Referring to FIG. 3, the electronic device 2 according to the second embodiment of the present invention includes a USB connection unit 100 provided to a main body of the electronic device, a VBUS detecting unit 101 that determines that a USB device has been connected to the USB connection unit 100, a USB control unit 102 that observes the states of D+ and D− terminals of the USB connection unit 100 and determines whether the connected USB device is a dedicated device for charging, a secondary battery 103 contained in the main body of the electronic device, a battery monitoring unit 204 that monitors the state of the secondary battery 103, a charging control unit 105 that charges the secondary battery 103, a switch (SW) 106 that is a switch unit that switches whether to supply power from the USB device connected to the USB connection unit 100 to the charging control unit 105, and a system control unit 207 that controls the switch (SW) 106 and the charging control unit 105 on the basis of outputs from the USB control unit 102 and the battery monitoring unit 204.

Here, the electronic device 2 according to the second embodiment is different from the electronic device 1 according to the first embodiment in that the system control unit 207 compares a remaining battery level included in the battery voltage information obtained from the battery monitoring unit 204 with a preset charging start threshold voltage for the remaining battery level.

Next, an operation of the electronic device 2 according to the second embodiment of the present invention will be described with reference to FIG. 4. FIG. 4 is a flow chart illustrating an operation of the electronic device 2 according to the second embodiment of the present invention. First, if a user connects a USB device to the USB connection unit 100 of the electronic device 2, the VBUS detecting unit 101 of the electronic device 2 detects that the USB device has been connected, in STEP S300, and notifies the system control unit 207 that the USB device has been connected, in STEP S301.

Next, if it is notified by the VBUS detecting unit 101 that the USB device has been connected, the system control unit 207 turns off the switch (SW) 106 in STEP S302.

Also, in STEP S201, it is determined whether a VBUS has detected that the USB device has been connected to the electronic device 2.

Next, in STEP S303, the system control unit 207 requests the USB control unit 102 to perform observation on the states of the D+ and D− terminals, and the USB control unit 102 notifies the system control unit 207 of the result of the observation on the states of the D+ and D− terminals. In a case where it is determined as the result of the observation of the USB control unit 102 on the D+ and D− terminals that the D+ and D− terminals have been short-circuited, the system control unit 207 determines that the connected USB device is a dedicated device for USB charging (‘Yes’ in STEP S303).

Then, the system control unit 207 turns on the switch (SW) 106 in STEP S305, and supplies power to the charging control unit 105, thereby immediately starting charging the secondary battery 103 in STEP S306.

Next, in a case where it is determined as the result of the observation of the USB control unit 102 on the states of the D+ and D− terminals that the D+ and D− terminals have not been short-circuited, the system control unit 207 determines that a device other than a dedicated device for USB charging has been connected using a general-purpose communication cable or the like (‘No’ in STEP S303).

Next, in STEP S304, the system control unit 207 obtains battery voltage information from the battery monitoring unit 204, and compares a remaining battery level with the preset charging start threshold voltage. In a case where the remaining battery level is the charging start threshold voltage or less, the system control unit 207 turns on the switch (SW) 106 in STEP S305, and supplies power to the charging control unit 105, thereby starting charging in STEP S306.

In a case where the remaining battery level is the charging start threshold voltage or larger (‘No’ in STEP S304), the system control unit 207 turns off the switch (SW) 106 such that charging does not start, until the remaining battery level becomes the charging start threshold voltage or less.

As described above, in the present embodiment, only in a case where a device other than a dedicated device for USB charging is connected, determination on whether to start charging is performed on the basis of the charging start threshold voltage, whereby it is possible to suppress facilitation of the cycle deterioration of the battery, thereby extending the life of the battery, while securing convenience. Further, although it has been described in the present embodiment that the determination is performed on the basis of the result of a single threshold value determination in consideration of processing time, the present invention is not limited thereto, but the determination may be performed on the basis of the results of multiple threshold value determinations.

Although the present invention has been described in detail with reference to the specific embodiments, it is apparent to those skilled in the art that it is possible to apply various alterations and corrections without departing from the spirit and scope of the present invention.

This application is based on Japanese Patent Application No. 2010-272194 filed on Dec. 7, 2010, and the contents of Japanese Patent Application No. 2010-272194 is incorporated here as a reference.

### INDUSTRIAL APPLICABILITY

The electronic devices according to the present invention that have a function of controlling start of charging according to a result of detection on a connected USB device have effects of being able to suppress facilitation of a cycle deterioration of a battery, thereby extending the life of the battery, while securing the convenience of charging.

### DESCRIPTION OF REFERENCE NUMERALS AND SIGNS

1, 2 ELECTRONIC DEVICE

100 USB CONNECTION UNIT

101 VBUS DETECTING UNIT

102 USB CONTROL UNIT

103 SECONDARY BATTERY

104, 204 BATTERY MONITORING UNIT

105 CHARGING CONTROL UNIT

106 SWITCH (SW)

107, 207 SYSTEM CONTROL UNIT

1. An electronic device comprising:
an electronic device main body;
a USB connection unit provided to the electronic device main body;
a VBUS detecting unit that determines that a USB device has been connected to the USB connection unit;
a USB control unit that detects whether D+ and D− terminals of the USB connection unit are short-circuited;
a battery contained in the electronic device main body;
a battery monitoring unit that monitors the state of the battery;
a charging control unit that charges the battery;
a switch that controls supply of power from the USB device connected to the USB connection unit to the charging control unit; and
a system control unit that controls the switch and the charging control unit,
wherein the VBUS detecting unit detects connection of the USB device; and
wherein if the USB control unit determines that the D+ and D− terminals of the USB connection unit are not short-circuited, when a battery voltage obtained from the battery monitoring unit is a preset threshold value or less, the system control unit starts charging of the battery.

2. The electronic device according to claim 1, wherein the VBUS detecting unit detects the connection of the USB device; and
wherein if the USB control unit determines that the D+ and D− terminals of the USB connection unit are short-circuited, charging of the battery is started.

3. The electronic device according to claim 1, wherein the VBUS detecting unit detects the connection of the USB device, and if the USB control unit determines that the D+ and D− terminals of the USB connection unit are not short-circuited, when the battery voltage obtained from the battery monitoring unit is a preset threshold value or larger, supply of power to the charging control unit is not performed.
